(19) United States
(12) Patent Application Publication
(10) Pub. No.: US 2010/0058288 A1
(43) Pub. Date: Mar. 4, 2010

(54) Method And System for Structuring a Software Implementation

(76) Inventors: Alexander Von Zitzewitz, Lexington, MA (US); Dietmer Menges, Dietramszell (DE); Peter Vieten, Munich (DE)

Correspondence Address: 24IP LAW GROUP USA, PLLC, 12 E. LAKE DRIVE, ANNAPOLIS, MD, 21403, US

(21) Appl. No.: 12/203,355

(22) Filed: Sep. 3, 2008

(51) Int. Cl. G06F 9/44

(52) U.S. Cl. 717/105

(57) ABSTRACT

The present invention refers to a method for structuring a software implementation with a plurality of modules, in particular, Java packages and for checking whether these modules fit a logical model. In a preparation phase the logical model will be defined and consists of two independent dimensions comprising a technical dimension and a business-driven-dimension. Further, allowed dependencies between the elements of the logical model, namely layers and slices, will be defined. In a subsequent implementation phase the modules of the software implementation will be assigned to the logical model. Further, monitoring is done in order to check whether the software implementation comprises any violations of the allowed dependencies. After assigning the modules to the logical model the logical model with the assigned modules will be visualised interactively and integrally and the allowed dependencies and any violations of the checked dependencies will be indicated.

### CROSS-REFERENCE TO RELATED APPLICATIONS

None.

### STATEMENT REGARDING FEDERALLY SPONSORED RESEARCH OR DEVELOPMENT

None.

### BACKGROUND OF THE INVENTION

1. Field Of The Invention

The present invention relates to a computer implemented tool for automatically assisting in a software implementation process, in particular though not exclusively, in which the software implementation is based on an object-oriented programming language, like C++, Java, etc.

2. Brief Description Of The Related Art

There are a number of methods and associated software tools available on the market, assisting a user to design and structure his software code to be implemented. These tools assist in evaluating the internal structure of the software, also called software architecture, and other basic characteristics related to technical quality of the software code.

Various modelling techniques are known in the art, and as an example, a previous commercial product, called SonarJ, is discussed here. SonarJ provides a software architect with the ability to define rules for the system to be implemented at a high level of abstraction. These rules are distributed to his development team and any violations of these rules are detected automatically. That is to say, as soon as the developer violates any of the rules the architect implemented, a marker immediately indicates the location in the code where the violation occurs. SonarJ, and in particular the version SonarJ 3.2, allows a designer to define a logical architecture. However, a possible drawback of SonarJ is that an integral graphical representation of this logical model, together with modules of the software implementation, is not incorporated. Moreover, the software architect is not able to gain relevant information with respect to his implementation. Therefore, there is a need for integrally visualising a logical model along with all modules of the software implementation and integrating these into the logical model.

A technique for structuring software is implemented in the product “Dependometer”. It is an open source product in which layers, slices, and subsystems are defined via an XML description. In this respect the terms “layer” and “slice” refer to logical elements for structuring a software implementation. A layer may be represented by a horizontal section, whereas a slice may be represented by a vertical section on a graphic representation. “Dependometer”, however, does not provide a graphical representation of the defined logical model.

Another tool known in the art is the product “Structure 101” developed by the company “Headway Software”. This product is also able to define layers that are subdivided into nested cells. The product does not, however, provide a logical structure in which the logical elements are clearly arranged.

Further, WO 02/23371 A2 also discloses a system for structuring complex systems. A matrix structure is disclosed, however, this matrix structure is adapted to represent dependencies of elements which are situated in the same level of hierarchy. Thus, the matrix structure of this document is not used for structuring the software implementation, but is only used for representing dependencies (existing/non-existing). This system does not visualise whether a software implementation fits a common logical structure.

### SUMMARY OF THE INVENTION

In the following the present invention will be described in relation to the method. Any aspects, features or advantages mentioned in this respect might also be applied to the other categories of the claims. These include a computer system, a computer readable medium, a user interface and a computer program product. The system and the product might also be adapted to incorporate features that are described in the description of the method. Any functional feature of the method refers to a module of an apparatus, having a particular functionality. For example the step of “defining” refers to a “definition module which is adapted to provide definitions.

In particular, the present invention relates to a system and a method for structuring a software implementation with a plurality of modules and for checking whether the modules of the software implementation fit a logical model, the method comprising:
defining the logical model by providing at least two independent dimensions for structuring, comprising at least a technical dimension having a plurality of layers and a business-driven dimension having a plurality of slices;
defining allowed dependencies between the layers or between the slices;
assigning the modules of the software implementation to the defined logical model;
checking whether the software implementation comprises violations of the allowed dependencies;
interactively and integrally visualising the logical model with the assigned modules and the allowed dependencies, any violations of the checked dependencies being indicated.

The present invention offers a significant improvement in performance and capabilities for a software design process. In particular, the structuring of a complex software implementation, based on a logical model, can be defined specifically for a particular implementation. More generally, the present invention offers an improvement in automated software development and provides a tool to assist the user in analyzing whether his software implementation fits a predefined logical model.

According to a first embodiment of the present invention, the allowed dependencies between logical components of the software implementation are controlled and managed automatically.

According to an aspect of the present invention, the method further comprises the ability to dynamically modify the logical model by adding, removing, or changing layers, slices or subsystems of the logical model in response to user input. Concurrently, the allowed dependencies of the amended model are automatically and interactively managed. This leads to a much higher degree of flexibility during software coding.

According to yet another aspect of the present invention, the method comprises a zooming function, such as to zoom in or out of an intersection point between one single layer and one single slice, having at least one and particularly a plurality of assigned modules. This aspect simply refers to the graphical representation of the plurality of assigned modules in the grid model. In general, there are a lot of modules which have to be assigned to one intersection point. Therefore, it might be difficult for a user to navigate and/or to find details with respect to a specific module. Thus, the invention provides a zooming function in order to be able to change the granularity of the representation.

According to another embodiment of the present invention, the method further provides an automatic mechanism or software function that assigns the software implementation modules to the logical grid model. Alternatively, this can be done manually. In the latter case a user might identify a specific module and incorporate the same via drag-and-drop-action to an intersection point of the grid model. In case the user wants to assign the module to a place in the grid model causing a dependency violation, he will be warned by a specific warning signal. In case software modules of an object oriented system should automatically be assigned to the logical model, this is done by type-related pattern matching. In general, these patterns may be defined for assignment to all logical elements of the system. The assignment of program code to the logic elements of the grid model normally is executed with patterns for types of the system, in case the software is object-oriented. Particularly, the pattern-matching is based on a name of the respective type that is defined in the program code along with so called namespaces thereof. Thus, the pattern-matching is based on a fully qualified name of the type in the program code

According to another aspect of the present invention, the method further automatically checks whether a violation of dependencies between implementation units or modules exists. In case such a violation is detected, a warning signal will indicate this violation. In additional embodiments of the present invention it is also possible to check for other violations. For example, there could be defined rules modifying legal and illegal dependencies between logical components, software implementation or other components.

According to yet another aspect of the present invention, the method provides an automatic ordering of the layers and of the slices. For the graphical visualisation the layers and the slices are ordered automatically, so that the upper most layers level is the one with the most dependencies, whereas the bottom layer has no dependencies at all. With respect to the slices, the slice furthest to the left shows the most dependencies to other slices. The ordering is calculated based on the level defined by allowed dependencies. To be more precise, layers without allowed dependencies are called layers at level 1. Layers with allowed dependencies to layers at level 1 are called layers at level 2, and so on. The levels for slices are calculated similarly. Further, the ordering is based on the no-cycle-policy. This assures that each layer and each slice has a unique level which can be used for the automatic ordering.

According to yet another aspect of the present invention the layers and the slices might be grouped or might be nested to form grouped or nested layers or slices. According to a similar but another aspect of the invention, the layers or the slices might be grouped or might be nested to form grouped or nested layers of slices.

A major principle according to the present invention is to be seen in the orthogonality between the two dimensions (layers and slices). Most of the actual software systems implemented with object-oriented coding might be structured within these two independent dimensions: one technical dimension and one business-driven dimension. The orthogonality leads to a grid model, wherein a slice intersects all layers and vice versa. Each unit of a complex software system, particularly if implemented in object-oriented code, might be assigned to such an intersection point. Normally, several units or modules of a software implementation will be assigned to one intersection point. The method according to an embodiment of the invention further defines subsystems. These subsystems are logical elements for structuring the intersection points of a slice with a layer. The definition of such subsystems is useful for getting more detailed information for parts or elements of such intersection points. Further, there could be defined access rights for such parts of an intersection point.

Emerging from the fact that a complex software system might be structured in the grid model, it is possible to easily display the structured software implementation in distinct clearly arranged modules. Based on this, a software developer could gain an overview over the state of a complex software development project. Also, all modules of the software implementation are clearly and well arranged in the grid model. Further, this grid structure with assigned modules might easily be maintained.

As a further advantage of the structuring, it is possible to get a high degree of quality, because each time there is a violation of dependency rules, this will be indicated by a warning signal. The signal could be an acoustic or an optical signal or a combination thereof.

A further relevant feature of the present invention is to be seen in the division into several phases of the method. There exists a preparation phase in which the rules and the logical structure are defined with the specific layers and the specific slices. This preparation phase comprises defining logical elements on a logical level. Particularly, the preparation phase only consists of defining logical elements. The second phase is an implementation phase, in which the software system is implemented. In this implementation phase newly generated modules or old modules being modified might be assigned to a logical model. According to the invention a logical model with the implementation units being assigned to it is automatically updated with new or modified modules. Each time the implementation changes, because e.g. there is a change in one single module, the visualisation of the software implementation being structured in the grid model also changes.

According to another aspect of the present invention, the preparation phase is completely independent of the implementation phase. This has a major advantage concerning flexibility, because logical architecture definition and implementation check could be separated.

As the visualised structured software implementation (grid model with assigned modules) is constantly updated, any errors based on a violation of pre-defined rules are quickly detected. This has the advantage that mistakes can be fixed earlier, even in the implementation phase and not in a successive testing phase. This allows to improve quality of the software implementation significantly.

Further, testability of a complex and huge program comprising a plurality of software modules might be improved as mistakes might be automatically and quickly detected if they are based on a violation of logical rules or logical dependencies.

A further advantage and feature of the present invention is that as soon as the logical model is defined, possibly down to a subsystem level, it is possible to check whether an implementation unit of software code fits this logical model and check if it violates predefined rules. As the first types of an object-oriented system are written, the software implementation can be mapped to the logical model that has been defined in the preparation phase. If the invention is adapted to do the assignments manually, then a selection of software modules can be made, which should be checked for fitting the logical model. That is to say, it is possible to select only a part of the software implementation on which the method according to the invention should be executed.

The present invention further offers a computer readable medium, having computer executable instructions for executing a method according to the method described above provided that the program is loaded onto a computer.

According to another aspect of the present invention a computer program product is provided having computer executable instructions for executing a method as described above. The computer program product might comprise a computer readable medium on which instructions are stored, for executing the method.

According to yet another aspect of the present invention a system for structuring a software implementation is provided, for structuring a software implementation having a plurality of modules and for checking whether the modules of the software implementation fit a logical model.

Further, the present invention relates to a graphical user interface usable for structuring a software implementation and for visualizing interactively and integrally the assigned modules to the logical model.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

In a preferred embodiment, the present invention is a method for structuring a software implementation with a plurality of modules and for checking whether the modules of the software implementation fit a logical model. The method comprises the steps of defining the logical model by providing at least two independent dimensions for structuring, the dimensions comprising at least a technical dimension having a plurality of layers and a business-driven dimension having a plurality of slices, defining allowed dependencies between the layers or between the slices, assigning the modules of the software implementation to the defined logical model, checking whether the software implementation comprises violations of the allowed dependencies, and interactively and integrally visualising the logical model with the assigned modules and the allowed dependencies, any violations of the checked dependencies being indicated. The method may further comprise the step of, in response to user input, dynamically modifying the logical model by adding, removing, or changing layers, slices or subsystems of the logical model and interactively managing the allowed dependencies of the modified model. The step of interactively and integrally visualising may comprise a zooming function, such as to zoom in or out of an intersection point between one layer and one slice, comprising at least one and particularly a plurality of assigned modules. The step of assigning the modules to the logical model may be performed automatically or manually. Further, the modules may be automatically assigned to the logical model by parsing the software implementation based on type-related pattern matching. The allowed dependencies may obey a no-cycles-policy for the software implementation. In another embodiment, the method may further comprise the step of checking a violation of physical dependencies between implementation units or modules of the software implementation. In still another embodiment, the method may further comprise the step of automatically ordering the layers and the slices, the ordering being calculated based on the level defined through allowed dependencies. The layers or slices may be grouped to form grouped layers or slices. The layers or slices may be nested to form nested layers or slices. Each violation of a checked dependency is indicated with a respective warning signal.

In another embodiment, the present invention is a computer readable medium having computer-executable instructions for performing the method described above. In yet another embodiment, the present invention is a set of computer-executable instructions for performing the above-described method, with the instructions being executed on a computer.

In another preferred embodiment, the present invention is a system for structuring a software implementation having a plurality of modules and for checking whether the modules of the software implementation fit a logical model. The system comprises (i) a graphical user interface for displaying an orthogonal logical model, wherein the logical model provides at least two independent dimensions for the purpose of structuring the software implementation, comprising at least a technical dimension having a plurality of layers and a business-driven dimension having a plurality of slices; (ii) a data structure suitable for storing and defining layers, slices and subsystems; (iii) a data structure suitable for storing a set of patterns which is used for assigning the modules of the software implementation to the defined logical model; (iv) a data structure suitable for storing and defining allowed dependencies between the layers or between the slices; (v) a validity checker for checking whether the software implementation comprises violations of the allowed dependencies, the validity checker being based on the data structure for storing the allowed dependencies; and (vi) a user interface controller for interactively and integrally visualizing the assigned modules and for visualizing any violations of the allowed dependencies upon receiving an indication from the validity checker about a detection of any violation. In response to a user input, the user interface controller may allow a user to dynamically modify the logical model with the assigned modules, wherein the logical model could be modified by adding, changing or removing slices, layers or subsystems, and interactively managing the allowed dependencies of the model on the basis of the data structure(s) and on the basis of received indications from the validity checker. The assignment may be generated automatically based on a type-related pattern or generated manually by a drag-and-drop functionality provided by the user interface controller for dragging a module to be assigned across the graphical user interface and for dropping the module onto a pre-selected one of interactive intersection points.

In another preferred embodiment, the present invention is a graphical user interface usable for structuring a software implementation having a plurality of modules and for checking whether the modules of the software implementation fit a logical model. The graphical user interface is adapted to display an orthogonal logical model, wherein the logical model provides at least two independent dimensions for the purpose of structuring the software implementation. The two dimensions comprise a technical dimension having a plurality of layers and a business-driven dimension having a plurality of slices. The graphical user interface comprises interactive graphical elements representing the layers, slices and intersection points of the orthogonal logical model. The graphical user interface interacts with a data structure suitable for storing and defining layers, slices and subsystems, a data structure suitable for storing a set of patterns, which is used for assigning the modules of the software implementation to the defined logical model, a data structure suitable for storing and defining allowed dependencies between the layers or between the slices, a validity checker for checking whether the software implementation comprises violations of the allowed dependencies, the validity checker is based on the data structure for storing the allowed dependencies, and a user interface controller for interactively and integrally visualizing the assigned modules and for visualizing any violations of the allowed dependencies upon receiving an indication from the validity checker about a detection of any violation.

### BRIEF DESCRIPTION OF THE DRAWINGS

For a more complete understanding of the present invention and the advantages thereof, reference is now made to the following description and the accompanying drawings, in which:

FIG. 1 is a schematic overview of a possible division or fragmentation of a software project with Java-Packages on which a model of the present invention might be based.

FIG. 2 is a schematic overview of a horizontal division of a software project, defining a plurality of technical layers.

FIG. 3 is a schematic overview with respect to a vertical division of a software project with a plurality of business-driven slices.

FIG. 4 is a schematic overview of a grid model according to one embodiment of the present invention with two orthogonal dimensions.

FIG. 5 is a schematic overview of an example according to an embodiment of the present invention with subsystems being defined in the grid model.

FIG. 6 is a schematic overview of an example of the present invention, showing subsystems and defined allowed dependencies between elements of the grid model.

FIG. 7 is a flowchart according to a preferred embodiment of the present invention.

FIG. 8 is a schematic overview to transfer and structure a software implementation in a grid model according to a preferred embodiment of the invention.

### DETAILED DESCRIPTION OF THE PREFERRED EMBODIMENTS

The following definitions of terms shall be used in describing the preferred embodiments of the present invention:

Herein, the term “structuring software implementation” means to transfer the real software modules into a predefined logical model.

A “module” is to be construed broadly as an item of software and might particularly be a set of types of an object-oriented system or set of compilation units. The logical model is based on at least two independent dimensions, which can be visualised in a grid model. It comprises a technical dimension, having a plurality of horizontal layers, and a business-driven dimension, having a plurality of vertical slices. These two dimensions are independent of each other. The technical structure of a software system is generally independent of a business-driven dimension. Horizontal layers and vertical slices are to be construed as logical elements for structuring a software system.

The term “layer” is to be construed as comprising distinct but related responsibilities. A layer is generally independent of a concrete business application to be implemented. Layers can only be modelled based on technical decisions (e.g. graphical user interface technology, persistence framework etc.). The layers, thus, relate to technical criteria or technical parameters, which might be database accesses, user interface-related matters, CPU (central processing unit)-related parameters, memory capacity etc. In this respect it is referred to the publication “Applying UML and Patterns”, Craig Larman, Prentice Hall 2002, particularly p. 450.

The term “slice” is to be construed as a dimension being independent of the software implementation. Basically, slices can be modelled based on a business process analysis. The dimension “slice” is based on the business-driven analysis of a software system to be implemented derived from use case analysis and the corresponding domain model. In general, a slice comprises elements of a domain model which are strongly coupled, along with all implementations necessary to present, modify or transport elements. In other words, the vertical slices are content-related or matter-related and, for example, might refer to a client management, a product management, a contract management etc. In this respect it is referred to the publication of Alistair Cockburn, “Writing Effective Use Cases”, Addison Wesley, 2001, page 155.

As by the present invention the logical model can be defined by comprising two independent dimensions, it is possible to represent the logical model as grid model. The grid model consists of horizontal layers and vertical slices, having intersection points. Particularly, any layer intersects any slice in the grid model.

The term “allowed dependencies” relates to principles of software architecture and refers to the situation where specific software modules might be used in other software modules. The usability or the ability to call a program module leads to an allowed dependency. A system for example comprising the layers “user interface”, “process”, “business logic” and “persistence” would probably have the following allowed dependencies:
“user interface” might use “process”
“process” might use “business logic”
“business logic” might use “persistence”.

This structure of defined dependencies is also denoted as “strict layering”. This means that a specific layer only might call a layer which is located directly beneath it. Other models may be applied, for example a layer can also use layers in addition to the ones directly beneath it. These less strict structuring models also might be called “relaxed layering”.

A software architecture principle says that no dependency cycles exist. Therefore, in an embodiment of the present invention, the logical model is based on a no-cycles-policy. In the example given above, the no-cycles-policy means that for example “persistence” must not use “user interface”. However, in other embodiments of the invention it is also possible to deviate from this principle.

The term “interactively and integrally visualizing the logical model” is to be construed as providing a graphical representation of the grid model in accordance with the invention together with assigned modules of the software implementation. A user may change or modify this representation by adding, removing or modifying elements of the grid model that is visualised. For example, it is possible for a user to add a further horizontal layer or a further vertical slice to the grid model. Moreover, it is possible that a user adds a single software module or a group of software modules manually to the grid model.

“Integrally visualizing” means that the pre-definable logical grid model is represented on the graphical user interface together with the assigned modules of the software implementation. In other words according to the present invention there only exists one single representation for both: for the logical model on the one hand and, on the other hand, for the software implementation modules that are assigned to the grid model. Before visualizing the logical model with the assigned software implementation modules, any violations of pre-definable allowed dependencies are checked. Further, the visualisation comprises a detection of any violations of the checked dependencies. An advantage of this visualisation is that a software developer may easily detect any violations of checked dependencies as soon as he has written the code.

Embodiments of a method for structuring a software implementation are described hereinafter. One skilled in the relevant art will recognize, however, that the invention can be practiced without one or more of the specific details, or with other methods, modules, entities etc. In other instances, well-known structures, computer related functions or operations are not shown or described in detail, as they will be understood by those skilled in the art.

Further, the method is described with respect to an object-oriented programming language, like Java. However, other categories of software or other projects might also be applied and processed, respectively. Furthermore, the particular features, structures or characteristics may be combined in any suitable manner in one or more embodiments.

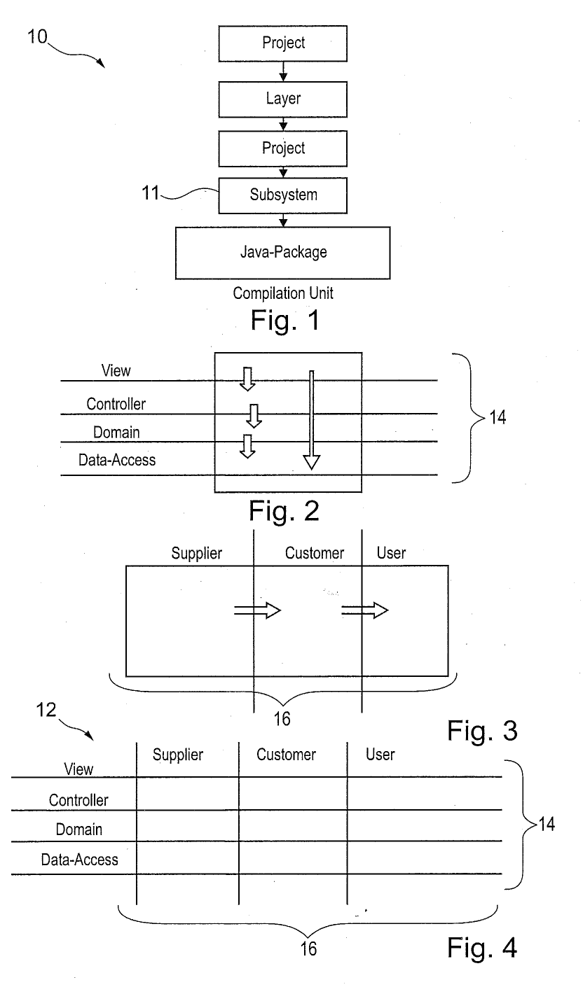

FIGS. 1-3 show an exemplary possibility to divide or structure a complex software project in different items. This structuring is a widely adopted method of describing an overall software architecture in a static way. A project may comprise different layers and different subsystems, wherein the subsystems themselves comprise packages. As the preferred embodiment the present invention relates to object-oriented coding of software, the packages might for example be Java-packages. Each of the packages might consist of compilation units.

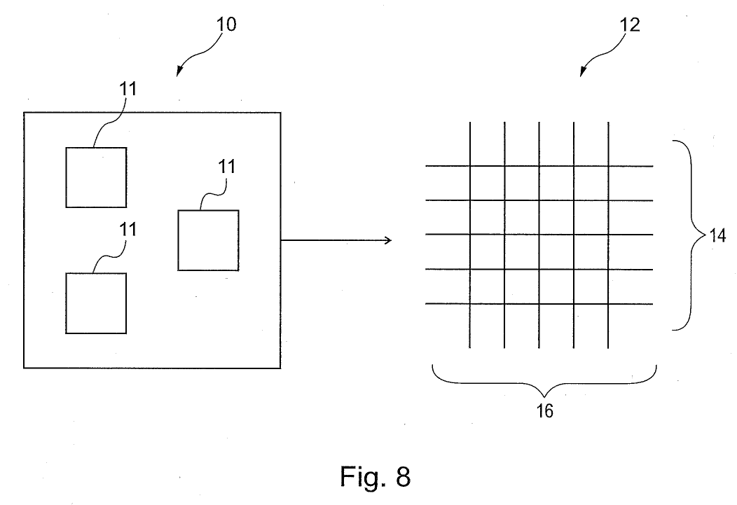

As shown in FIG. 8, the invention generally is related to a computer implemented solution for structuring a software implementation 10 with a plurality of modules 11 and for checking whether the modules 11 of the software implementation 10 fit a logical model 12. In FIG. 8 the logical model 12 is indicated with a grid structure comprising layers 14 and slices 16.

In a first preparation phase a logical model 12 is defined. It is possible to provide the logical model 12 manually or to provide the same by adapting a given software model from other software projects. The logical model 12 has at least two independent dimensions for structuring. First, there is a technical dimension having a plurality of (horizontal) layers 14 and second, there is a business-driven dimension having a plurality of (vertical) slices 16.

Also, in the preparation phase it is possible to define allowed dependencies 18 between the layers 14 or between the slices 16. In an alternative embodiment it is also possible to define disallowed dependencies between elements of the model 12.

Subsequent to the preparation phase there is an implementation phase which could be executed at any point in time after having finalised the preparation phase and which therefore is independent of the preparation phase. In the implementation phase a software implementation 10 is provided which has to be structured. The modules 11 of the software implementation 10 are to be assigned to the defined logical model 12. This assignment can be done manually or automatically.

As a next step in the implementation phase it could be checked whether software implementation 10 comprises any violations of the allowed dependencies 18 that have been defined in the preparation phase.

Further, in the implementation phase it is possible to visualise the logical orthogonal model 12 along with assigned modules 22 and also along with the allowed dependencies 18. Any violations of the checked dependencies 18 will be highlighted or indicated separately, for example with another warning signal. In other words, if there are any violations detected, these are indicated concomitantly and simultaneously in the visualised graphical representation of the grid model 12.

In FIG. 2 the definition of layers is explained in more detail. Several technical layers can be defined for the respective software project, describing the technical dimension of the software project. In FIG. 2 there are four layers. The uppermost layer “View” is based on the layers “Controller” and “Data-access”. The layer “Controller” is based on the underlying layer “Domain”, which is based on the lowest layer “Data-access”. These layers are only a simplified example and may not be appropriate for an actual project. However, this might be used for showing the technical dependencies between the pluralities of horizontal layers 14 according to the present invention.

FIG. 3 shows by way of example a plurality of vertical slices 16 of the grid model 12. The slices “Supplier”, “Customer” and “User” are displayed. These slices 16 comprise the business-driven dimension of the grid model 12.

FIG. 4 shows a grid model 12, in which these two dimensions (horizontal and vertical) are depicted in more detail. The respective layers 14 and the respective slices 16 are structured in the logical grid model 12 as independent orthogonal dimensions.

According to the present invention it is possible to structure a software implementation 10 and to define different subsystems within the logical model 12. The following types of subsystems could be defined:
1. Direct subsystems within the project;
2. Subsystems within a layer group;
3. Subsystems in an intersection point 20 between a layer group and a vertical slice group;
4. A subsystem within a layer 14;
5. A subsystem with an intersection point 20 between a layer 14 and a vertical slice 16; and
6. A subsystem within an intersection point 20 between a layer group a vertical slice group, as well as a layer of the layer group.

If an element of the grid model 12 being visualised is selected, in the graphic representation this element will be flagged or designated separately. For example this element will be visualised in bold type.

It has to be mentioned that up to now—that is with respect to FIG. 1 to FIG. 4—there is only a definition of logical elements of the logical model 12, i.e. on a logical or abstract level and independently of the software implementation itself. This definition is executed in the preparation phase. The real software implementation 10 is not needed for executing preparatory steps in the preparation phase of the invention. In other words, the preparation phase and the steps therein may be executed independently of the steps related to the implementation phase with the software implementation 10.

As already explained above in the implementation phase, the modules 11 of the software implementation 10 are assigned to fit in the grid model 12. After having assigned the modules 11 the assigned modules 22 are visualised graphically. The graphic representation comprises the assigned modules 22 and shows them in the grid model 12. Further, the dependency structure 18 is shown. Generally, the allowed dependencies 18 and also disallowed dependencies are shown. In a preferred embodiment the disallowed dependencies refer to any violations of the defined checked dependencies 18. Any violations are highlighted or marked separately.

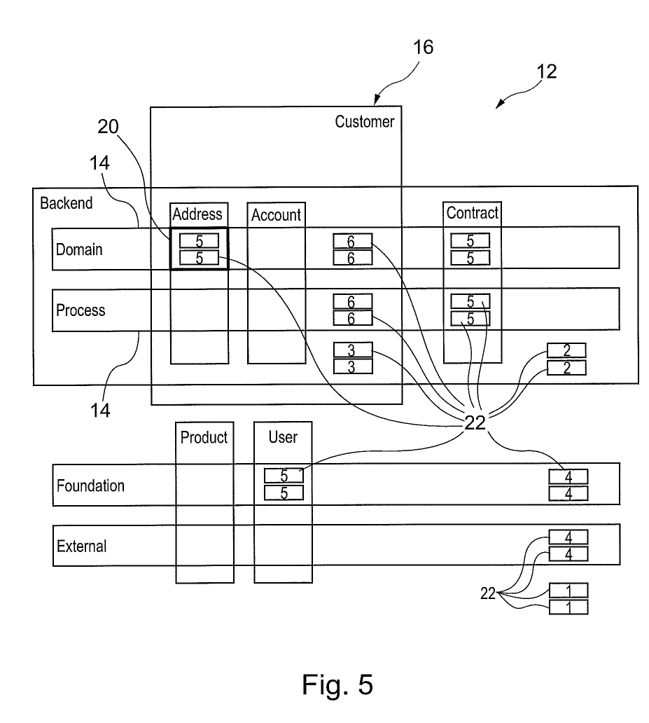

FIG. 5 visualises the logical model 12 with the assigned modules 22. FIG. 5 refers to a software implementation 10 prototypical for an insurance system. In order to keep the FIG. 5 as clear as possible, there is only depicted one vertical slice 16, namely the slice “Customer”. Further, only the horizontal layers 14 “Domain” and “Process” as “Backend” layers are shown. The small rectangular boxes refer to assigned modules.

Within the grid model 12, consisting of a plurality of slices 16 and a plurality of layers 14, modules on different levels in the grid model 12 can be assigned. For example in FIG. 5 the intersection point of layer “Address” and slice “Account” consists of two assigned modules “5”. More general, assigned modules denoted by “5” are assigned to an intersection point of a layer 14 and a vertical slice 16. But assigned modules can also be assigned outside any logical element (which, for example, in FIG. 5 is shown by assigned modules 22 designated by a “1”), directly to a layer group (which, for example, in FIG. 5 is shown by assigned modules 22 designated by a “2”), to an intersection point of a layer group and a vertical group (which, for example, in FIG. 5 is shown by assigned modules 22 designated by a “3”), directly to a layer (which, for example, in FIG. 5 is shown by assigned modules 22 designated by a “4”) or to a layer inside an intersection point of layer group and vertical slice group (which, for example, in FIG. 5 is shown by assigned modules 22 designated by a “6”).

In the graphic representation shown in FIG. 5, a layer 14 can be selected. If a specific layer 14 is selected, in the representation this layer 14 will be optically marked. Furthermore, all such layers 14 are optically highlighted for which allowed dependencies 18 with respect to the selected layers have been defined. These layers 14 having allowed dependencies in relation to the respective selected layer will be highlighted in another manner, so that it is possible to distinguish between them.

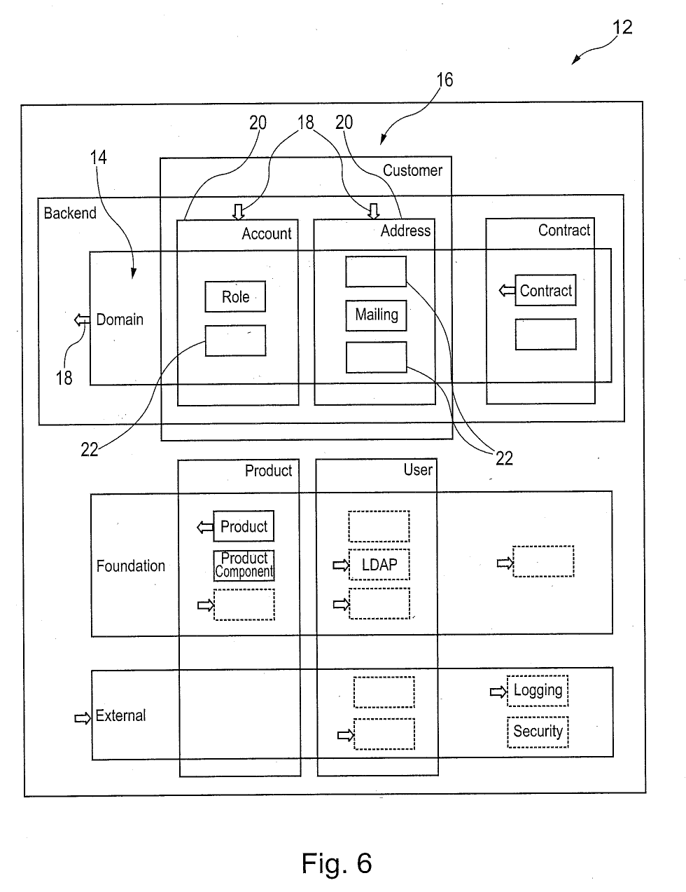

With respect to FIG. 6 the definition of allowed dependencies 18 is explained and the visualisation of the same along with the grid model 12. In FIG. 6 the grid model 12 is shown with subsystems and with the defined dependencies 18. The defined (allowed and disallowed) dependencies 18 are visualised with arrows from or to the respective element of the grid model 12. The subsystem 22 “Role” is assigned to the intersection point of slice “Account” and layer 14 “Domain”. Further, the assigned module 22 “Mailing” is assigned to “Address”. The subsystem 22 “Address” is an intersection point of the vertical slice 16 “Customer” with the horizontal layer 14 “Domain”. Thus and as an advantage, in the grid model 12 the respective intersection point 20 between a respective layer 14 and a respective slice 16 may be shown.

Generally, the structuring according to the present invention allows defining different types of allowed dependencies 18. There might be allowed dependencies 18 of a first intersection point 20 to another intersection point 20′ of a different layer 14′, but within the same vertical slice 16. This allowed dependency is named “vertical”. Further, it is possible to define allowed dependencies 18 between an intersection point 20 of another intersection point 20′ of another layer 14′ of another vertical slice 16′. This type of allowed dependency 18 is called “diagonal”.

The grid model 12 according to the present invention allows vertical and diagonal intersection dependencies to be defined. Further, layer and slice dependencies as allowed dependencies 18 can be defined. The different types of allowed dependencies 18 are highlighted separately. With this aspect according to the present invention the user has the advantage of more easily and rapidly understanding the structure of the software implementation 10.

Generally, allowed dependencies 18 might be defined between the subsystems with configurable limitations. For example one possible limitation is that the structuring does not allow for any cycles. Further, the possibility exists of defining other limitations.

In the implementation phase the method according to the invention comprises visualising the logical model 12 with the assigned modules 22 along with the allowed dependencies 18, whereby any violations of the checked and allowed dependencies 18, being indicated separately. However, not only the violations of the checked dependencies 18 are being indicated separately. There are different optical indications for the following subsystems:
1. For the selected subsystem;
2. For all subsystems, for which an allowed dependency with the selected subsystem as incoming-subsystem may be defined;
3. For all subsystems for which an allowed dependency of the selected subsystem as incoming-subsystem is defined;
4. For all subsystems for which an allowed dependency to the selected subsystem as outgoing-subsystem is defined. The terms “incoming-subsystem” and “outgoing-subsystem” shall be construed that an incoming-subsystem refers to an input or source subsystem and in that the outgoing-subsystem refers to an output or target subsystem on a functional level.

Further and according to the present invention, it also is possible to define allowed dependencies 18 for the intersection points 20 of a respective layer 14 and the respective slice 16. It is possible to select an intersection point 20 in a separate model 12. If such an intersection point 20 is selected it will be visualised emphasized.

According to the description given above referring to allowed dependencies 18 for subsystems also allowed dependencies 18 for intersection points 20 might be divided into different types. All different types of allowed dependencies 18 will be highlighted separately. According to a preferred embodiment of the present invention the following allowed dependencies 18 with respect to the intersection points 20 might be differentiated:
1. The selected intersection point 20;
2. All intersection points 20 for which an allowed dependency with the selected intersection point as incoming intersection point 20 might be defined;
3. All intersection points 20 for which an allowed dependency of the selected intersection point, being an outgoing intersection point 20 is defined;
4. All intersection points 20 for which an allowed dependency to the selected intersection point as outgoing intersection point 20 is defined.

Based on the structure of the logical model 12 it is not necessary to define further limitations.

According to the explanation given above with respect to allowed dependencies 18 for intersection points 20 and for subsystems it is also possible to define allowed dependencies 18 between layer groups and vertical slice groups.

Generally, it is possible to define groups comprising several layers to form layer groups and it is possible to group several slices to form slice groups. Further, different allowed dependencies 18 exist, which are highlighted separately in the visualised grid model 12. The following allowed dependencies 18 exist for groups of layers and groups of slices respectively:
1. The selected group of layers (also called layer group);
2. All layer groups for which it is possible to define an allowed dependency with the selected layer group as an incoming layer group;
3. All layer groups for which an allowed dependency of the selected layer group as incoming layer group is defined;
4. All layer groups for which an allowed dependency to the selected layer group as outgoing layer group is defined.

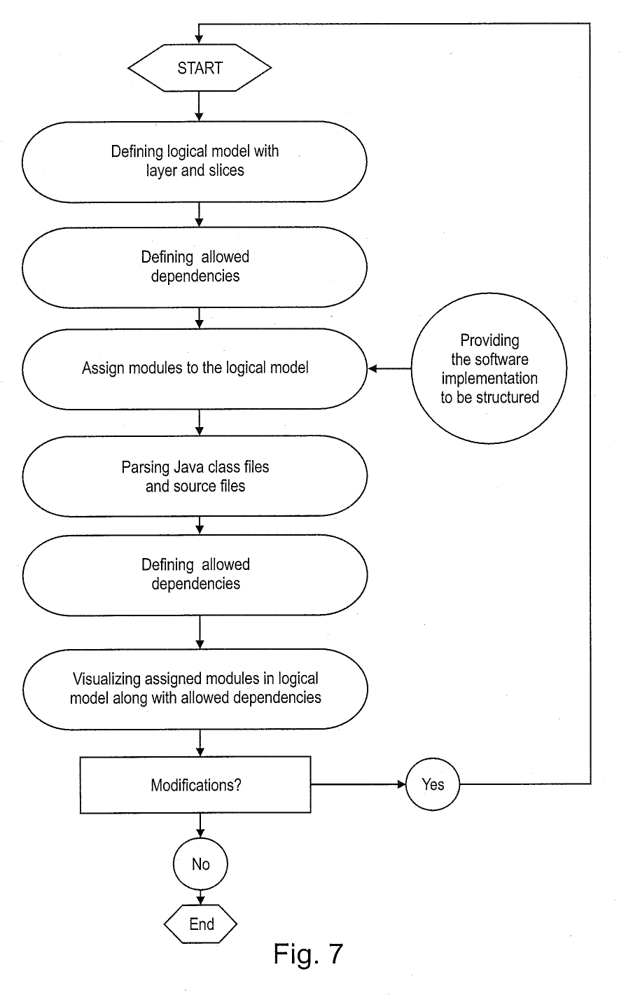

With respect to FIG. 7 the method for structuring a software implementation 10 will be explained in more detail. After starting the method according to the present invention and in the preparation phase the logical model 12 will be defined. Particularly, the technical dimension with a plurality of layers 14 and the business-driven dimension with the plurality of vertical slices 16 are defined.

After this or concomitantly to this, allowed dependencies 18 may be defined. Otherwise, they might be adapted from other projects.

After providing the software implementation code 10 to be structured with the plurality of modules 11, the modules 11 will be assigned to the logical model 12. The modules 11 are made known to the system by parsing the underlying implementation code (e.g. Java class and source files in case of a Java project). Once, the modules 11 are assigned they become assigned modules 22. The difference between the modules 11 and the assigned module 22 is that the assigned modules 22 are already fit in the logical model 12. The assignment takes place in the implementation phase which follows the preparation phase. The assignment might be executed manually by a drag-and-drop operation via a computer mouse interaction of the user or automatically by pattern matching. All internal dependencies will be checked and the code is examined whether it conforms to the rules of the logical model 12. Normally, directly after assigning the modules to the logical model 12, there is a check whether the software implementation 10 violates any defined allowed dependencies 18 of the logical model 12. Any violations will be highlighted in the graphical representation of the logical model 12. In this step the assigned models 22 within the logical model 12, along with the allowed and disallowed dependencies being marked, will be visualised in the graphical representation.

Unless there are modifications, the method ends after this step. Otherwise, if there are any modifications concerning the software implementation 10 as such or with respect to the model 12 or with respect to the allowed dependencies 18 or with respect to the assignment, the method starts again in order to adjust or update the graphical representation.

In other words any modification leads to an automatic adaption and update of the logical model, being visualised as grid model 12.

Preferably, any dependencies are highlighted separately. According to this aspect the user automatically and rapidly may get an overview if there are any violations of allowed dependencies 18. If any such violations are detected, the user will be presented with a description where these violations occur, particularly in which module 11 of the software implementation 10.

The presented description of illustrated embodiments of the invention is not intended to be exhaustive or to limit the invention to precise forms disclosed. While specific embodiments of, and examples for, the invention are described herein for illustrative purposes various equivalent modifications are possible within the scope of the invention and can be made without deviating from the scope of the invention.

For example, to some extent the description is based on structuring a software project for an insurance system. Alternatively, projects in any other field or area might also be used for the method and system according to the invention, like projects in information technology, electrical or mechanical engineering, physics, administration, management, etc.

Further, the method might be implemented in software, in coded form to be used in connection with a computer. Alternatively, it is possible to implement the method according to the invention in hardware or hardware modules. The hardware modules are then adapted to perform the functionality of the steps of the method. Furthermore, it is possible to have a combination of hardware and software modules.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What we claim is:

1. A method for structuring a software implementation with a plurality of modules and for checking whether the modules of the software implementation fit a logical model, the method comprising:
defining the logical model by providing at least two independent dimensions for structuring, the dimensions comprising at least a technical dimension having a plurality of layers and a business-driven dimension having a plurality of slices,
defining allowed dependencies between the layers or between the slices;
assigning the modules of the software implementation to the defined logical model;
checking whether the software implementation comprises violations of the allowed dependencies;
interactively and integrally visualising the logical model with the assigned modules and the allowed dependencies, any violations of the checked dependencies being indicated.

2. A method according to claim 1, further comprising the step of:
in response to user input, dynamically modifying the logical model by adding, removing, or changing layers, slices or subsystems of the logical model and interactively managing the allowed dependencies of the modified model.

3. A method according to claim 1, wherein the step of interactively and integrally visualising comprises a zooming function, such as to zoom in or out of an intersection point between one layer and one slice, comprising at least one and particularly a plurality of assigned modules.

4. A method according to claim 1, wherein the step of assigning the modules to the logical model is performed automatically.

5. A method according to claim 1, wherein the step of assigning the modules to the logical model is performed manually.

6. A method according to claim 4, wherein, the modules are automatically assigned to the logical model by parsing the software implementation based on type-related pattern matching.

7. A method according to claim 1, wherein the allowed dependencies obey a no-cycles-policy for the software implementation.

8. A method according to claim 1, further comprising the steps of:
checking a violation of physical dependencies between implementation units or modules of the software implementation.

9. A method according to claim 1, further comprising the step of:
automatically ordering the layers and the slices, the ordering being calculated based on the level defined through allowed dependencies.

10. A method according to claim 1, wherein the layers or slices are grouped to form grouped layers or slices.

11. A method according to claim 1, wherein the layers or slices are nested to form nested layers or slices.

12. A method according to claim 1, wherein each violation of a checked dependency is indicated with a respective warning signal.

13. A system for structuring a software implementation having a plurality of modules and for checking whether the modules of the software implementation fit a logical model, the system comprising:
a graphical user interface for displaying an orthogonal logical model, wherein the logical model provides at least two independent dimensions for the purpose of structuring the software implementation, comprising at least a technical dimension having a plurality of layers and a business-driven dimension having a plurality of slices;
a data structure suitable for storing and defining layers, slices and subsystems;
a data structure suitable for storing a set of patterns which is used for assigning the modules of the software implementation to the defined logical model;
a data structure suitable for storing and defining allowed dependencies between the layers or between the slices;
a validity checker for checking whether the software implementation comprises violations of the allowed dependencies, the validity checker being based on the data structure for storing the allowed dependencies; and
a user interface controller for interactively and integrally visualizing the assigned modules and for visualizing any violations of the allowed dependencies upon receiving an indication from the validity checker about a detection of any violation.

14. A system according to claim 13, wherein in response to a user input, the user interface controller allows dynamically modifying the logical model with the assigned modules, wherein the logical model could be modified by adding, changing or removing slices, layers or subsystems, and interactively managing the allowed dependencies of the model on the basis of the data structure(s) and on the basis of received indications from the validity checker.

15. A system according to claim 13, wherein the assignment is generated automatically based on a type-related pattern.

16. A system according to claim 13, wherein the assignment is generated manually by a drag-and-drop functionality provided by the user interface controller for dragging a module to be assigned across the graphical user interface and for dropping the module onto a pre-selected one of interactive intersection points.

17. A graphical user interface usable for structuring a software implementation having a plurality of modules and for checking whether the modules of the software implementation fit a logical model, wherein the graphical user interface is adapted to display an orthogonal logical model, wherein the logical model provides at least two independent dimensions for the purpose of structuring the software implementation, the two independent dimensions comprising a technical dimension having a plurality of layers and a business-driven dimension having a plurality of slices, the graphical user interface comprising interactive graphical elements, representing the layers, slices and intersection points of the orthogonal logical model; wherein the graphical user interface interacts with:
a data structure suitable for storing and defining layers, slices and subsystems;
a data structure suitable for storing a set of patterns, which is used for assigning the modules of the software implementation to the defined logical model;
a data structure suitable for storing and defining allowed dependencies between the layers or between the slices;
a validity checker for checking whether the software implementation comprises violations of the allowed dependencies, the validity checker is based on the data structure for storing the allowed dependencies; and
a user interface controller for interactively and integrally visualizing the assigned modules and for visualizing any violations of the allowed dependencies upon receiving an indication from the validity checker about a detection of any violation.
